(19) United States
(12) Patent Application Publication
(10) Pub. No.: US 2007/0211587 A1
(43) Pub. Date: Sep. 13, 2007

(54) OPTICAL DISK APPARATUS AND DISK DISCRIMINATION METHOD

(76) Inventor: Masanori Kosaki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/680,164

(22) Filed: Feb. 28, 2007

(30) Foreign Application Priority Data
Mar. 9, 2006 (JP) 2006-064337

(51) Int. Cl. G11B 7/00

(52) U.S. Cl. 369/44.29; 369/44.35; 369/53.14

(57) ABSTRACT

A controller of an optical disk apparatus moves a pickup head to a data area of an optical disk, and radiates a first DVD laser beam to the optical disk. The controller measures, as a first eccentricity amount, a number of beams, which have crossed a track on the optical disk, from a first tracking error signal from a head amplifier. The controller determines that the optical disk is a data-recorded first DVD optical if the controller determines that the measured first eccentricity amount is less than a predetermined reference value. The controller determines that the optical disk is a second DVD optical disk or the first DVD optical disk with a large eccentricity amount if the controller determines that the measured first eccentricity amount is greater than the predetermined reference value.

### CROSS-REFERENCE TO RELATED APPLICATIONS

This application is based upon and claims the benefit of priority from prior Japanese Patent Application No. 2006-064337, filed Mar. 9, 2006, the entire contents of which are incorporated herein by reference.

### BACKGROUND OF THE INVENTION

1. Field of the Invention

The present invention relates to an optical disk apparatus which is capable of using a plurality of kinds of optical disks, and a disk discrimination method for use in the optical disk apparatus.

2. Description of the Related Art

In recent years, a plurality of kinds of optical disks, which have the same outer shape but have different recording capacities, have been developed. For example, there are CD (Compact Disk)-series disks (e.g. CD-ROM, CD-R and CD-RW), DVD (Digital Versatile Disk)-series disks (DVD-ROM, DVD-RAM, DVD-R, DVD-RW, DVD+R and DVD+RW), and an HD-DVD (High Definition DVD) using a blue laser. An optical disk apparatus, which can handle a plurality of kinds of optical disks with different recording formats, is required to discriminate the kind of an optical disk that is loaded.

In the prior art, there has been proposed a disk discrimination apparatus which discriminates the kind of disk (see Jpn. Pat. Appln. KOKAI Publication No. 11-213529). In this disk discrimination apparatus, in the state in which a focus servo is effected, the disk is rotated and the pickup head is moved across tracks by a predetermined distance. At this time, a read signal is monitored, thereby to count the number of tracks over which the pickup head has crossed. Taking advantage of the fact that the DVD has a track pitch of 0.74 μm and the CD has a track pitch of 1.6 μm and the DVD has about double the number of tracks of the CD, the disk discrimination apparatus discriminates whether the currently loaded disk is a DVD or a CD.

The conventional disk discrimination apparatus can discriminate between the CD and DVD which have different track pitches, on the basis of the number of tracks that is detected by moving the pickup head across tracks by a predetermined distance while the disk is being rotated.

In Jpn. Pat. Appln. KOKAI Publication No. 11-213529, however, the track pitch of each of the DVD and CD can be measured by using a laser beam for the DVD, which has a smaller beam spot. If this prior art is applied to the discrimination between the HD-DVD and DVD, the track pitch of each of the HD-DVD and the DVD would be measured by using a laser beam for the HD-DVD, which has a smaller beam spot. In this case, the laser beam for the HD-DVD is radiated on a recordable DVD such as a DVD-R and a DVD+R, leading to a possible damage to the recording surface of the DVD.

The optical disk apparatus which can handle the HD-DVD may adopt the following method for discriminating whether a disk that is loaded is a DVD or an HD-DVD. That is, a red laser for the DVD is used to execute data read. If it is confirmed that data is recorded as HD-DVD data or that no data could successfully be read, the loaded disk is discriminated to be the HD-DVD.

In this discrimination method, however, a control for exactly reading data is executed. As a result, a longer processing time is needed than in the case of executing disk discrimination on the basis of a signal that is detected from the optical disk. In addition, in order to confirm that no data could successfully be read, it is necessary to execute the data read operation several times (re-try operation) for the confirmation. Thus, a certain length of processing time is needed.

### BRIEF SUMMARY OF THE INVENTION

According to an aspect of the present invention, there is provided an optical disk apparatus in which one of a first DVD optical disk and a second optical DVD optical disk is loadable, there being at least a plurality of kinds of the first DVD optical disks and at least a plurality of kinds of the second DVD optical disks, the second DVD optical disk having a smaller track width than the first DVD optical disk, the apparatus comprising, a motor which rotates the optical disk that is loaded at one of a first rotation speed and a second rotation speed which is twice or more higher than the first rotation speed, a pickup head which radiates one of a first DVD laser beam and a second DVD laser beam to the optical disk via an objective lens, and receives reflective light from the optical disk, a movement mechanism which moves the pickup head in a radial direction of the optical disk, a head amplifier which receives the reflective light from the pickup head, and outputs at least a focus error signal, a first tracking error signal by a DPD method, and a second tracking error signal by a PP method, a driving mechanism which drives the pickup head on the basis of the focus error signal, and one of the first and second tracking error signals, thereby executing a focus ON control and a track positioning control, and a controller which controls the motor, the pickup head, the movement mechanism, the head amplifier and the driving mechanism, wherein the controller controls the movement mechanism to move the pickup head to a data area of the optical disk, while controlling the motor to rotate the optical disk at the first rotation speed, controls the pickup head to radiate the first DVD laser beam to the optical disk, measures, as a first eccentricity amount, a number of beams, which have crossed a track on the optical disk during rotation of the optical disk, from the first tracking error signal which is output from the head amplifier, compares the measured first eccentricity amount with a predetermined reference value, and determines that the loaded optical disk is a data-recorded the first DVD optical in a case where the first eccentricity amount is less than the reference value, and determines that the loaded optical disk is the second DVD optical disk or the first DVD optical disk with a large eccentricity amount in a case where the first eccentricity amount is greater than the reference value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an optical disk apparatus according to an embodiment of the present invention;

FIG. 2 is a flow chart for describing a first disk discrimination process according to the embodiment;

FIG. 3 is a view for explaining the generation of a DPD signal by a DPD method;

FIG. 4 is a view for explaining the generation of a DPP signal by a DPP method;

FIG. 5 is a view showing eccentricity amounts which are measured at different rotational speeds; and

FIG. 6 is a flow chart for describing a second disk discrimination process according to the embodiment.

### DETAILED DESCRIPTION OF THE INVENTION

An embodiment of the present invention will now be described with reference to the accompanying drawings.

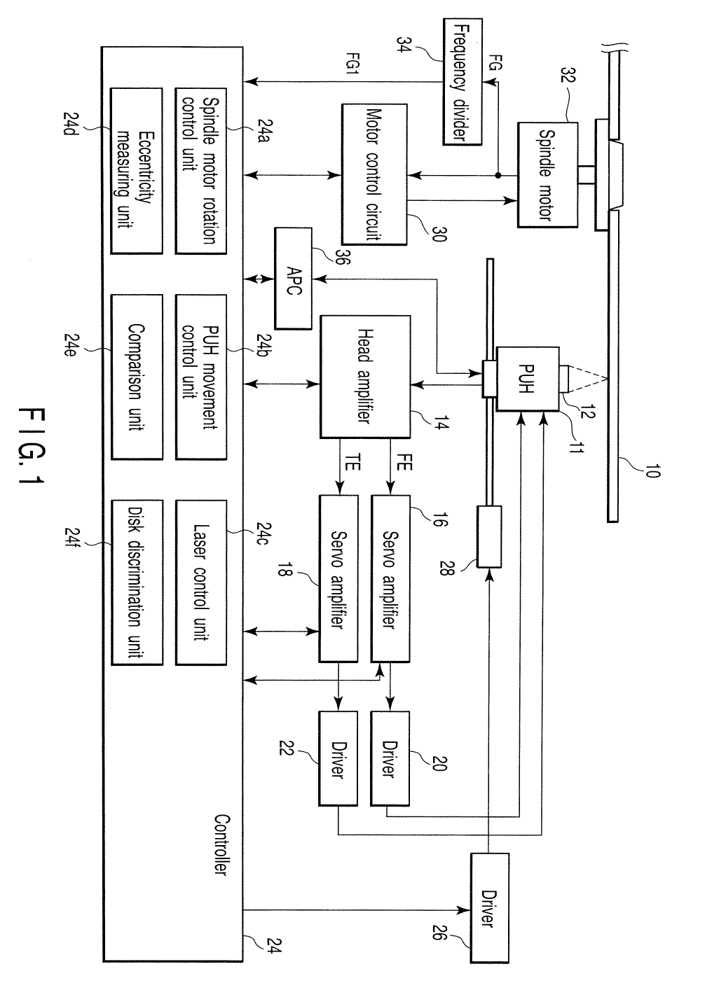

FIG. 1 is a block diagram showing the structure of an optical disk apparatus according to the embodiment.

Spiral tracks are formed on an optical disk 10 that is a recording medium, and the optical disk 10 is rotated by a spindle motor 32. In the optical disk apparatus according to the embodiment, it is assumed that three kinds of optical disks, that is, a compact disk (CD), a digital versatile disk (DVD) and a high definition DVD (HD-DVD), are usable as the optical disk 10. CD-series disks include a CD-ROM, a CD-R and a CD-RW. DVD-series disks include a DVD-ROM, a DVD-RAM, a DVD-R, a DVD-RW, a DVD+R and a DVD+RW.

Recording/reproduction of information on/from the optical disk 10 is effected by a laser beam which is emitted from a pickup head (PUH) 11.

The pickup head 11 includes a laser diode, a collimator lens, a beam splitter, an objective lens 12, a cylindrical lens, a photodetector, and a lens position sensor. The pickup head 11 is provided with a focus actuator which adjusts focusing by moving the objective lens 12 in a focusing direction (i.e. an optical axis direction of the lens), and a tracking actuator which adjusts tracking by moving the objective lens 12 in a tracking direction (i.e. a radial direction of the optical disk 10).

The laser diode emits a laser beam by a driving control using a laser control unit (not shown). The laser beam emitted from the laser diode travels through the collimator lens, the beam splitter and the objective lens 12, and falls on the optical disk 10. Reflective light from the optical disk 10 is guided to the photodetector via the objective lens 12, the beam splitter and the cylindrical lens. The photodetector comprises, e.g. 4-division photodetector cells, and outputs detection signals from the photodetector cells to a head amplifier 14.

The laser diode (not shown) outputs a laser beam by a driving control of an APC (Auto Power Control) 36. Under the control of a controller 24, the APC 36 drives the laser diode at the time of reproduction (or recording) in accordance with a power detection result so as to make constant the intensity of the laser beam that is output from the laser diode.

In the optical disk apparatus according to the embodiment, a plurality of laser diodes, which emit laser beams of different wavelengths, are provided. Specifically, an infra-red laser for CD (wavelength: 780 nm), a red laser for DVD (wavelength: 650 nm) and a blue laser for HD-DVD (wavelength: 405 nm) are provided. The APC 36, under the control of the controller 24, enables one of these laser diodes to emit a laser beam.

The laser beam emitted from the laser diode passes through the collimator lens, the beam splitter and the objective lens 12 and falls on the optical disk 10. The laser beam reflected from the optical disk 10 is led to the photodetector via the objective lens 12, the beam splitter and the cylindrical lens.

The photodetector comprises, e.g. 4-division photodetector cells A, B, C and D. The photodetector outputs detection signals from the photodetector cells A, B, C and D to the head amplifier 14.

The head amplifier 14 processes the signal from the photodetector, and produces a tracking error signal TE which indicates an error between a beam spot center of the laser beam and a track center, and a focus error signal FE which indicates an error from a just-focus position, for example, an all-addition signal (RF signal) in which the signals from the 4-division photodetector cells of the photodetector are added.

The head amplifier 14 generates the focus error signal FE as FE=(A+C)−(B+D). In addition, the head amplifier 14 generates, as the tracking error signal TE, a tracking error signal TE (PP (Push-Pull)) which is produced by a push-pull method, and a tracking error signal TE (DPD (Differential Phase Detection)) which is produced by a phase difference method. The head amplifier 14 generates the tracking error signal TE (PP) by the push-pull method as TE(PP)=(A+D)−(B+C). The head amplifier 14 generates the tracking error signal TE (DPD) by the phase difference method as TE(DPD)=φ(A+C)−φ(B+D). In the description below, the tracking error signal TE(DPD) is referred to as “DPD signal”, and the tracking error signal TE(PP) as “PP signal”.

The controller 24 executes a disk discrimination process for discriminating the kind of the optical disk 10 that is loaded, on the basis of the signals generated from the head amplifier 14. The details of the disk discrimination process will be described later.

The focus error signal FE from the head amplifier 14 is output to a servo amplifier 16, and the tracking error signal TE (DPD signal, PP signal) is output to a servo amplifier 18.

The servo amplifier 16 controls a driver 20 in accordance with the focus error signal FE, and causes the driver 20 to output a focus driving signal to a focusing actuator (not shown) of the pickup head 11.

The focusing actuator is driven by the focus driving signal from the driver 20, and a focus servo is executed to bring the laser beam emitted from the objective lens 12 of the pickup head 11 just in focus on the recording film of the optical disk 10.

The servo amplifier 18 controls a driver 22 in accordance with the tracking error signal TE (DPD signal, PP signal) which is output from the head amplifier 14, and causes the driver 22 to output a tracking control signal to a tracking actuator (not shown) of the pickup head 11.

The tracking actuator is driven by the tracking control signal from the driver 22, and a tracking servo is executed to make the laser beam emitted from the objective lens 12 of the pickup head 11 constantly trace the track on the optical disk 10.

The spindle motor 32 is provided with a frequency generator (FG) which generates a signal in accordance with a rotational angle. The frequency generator (FG) generates FG signals corresponding to a rotational angle, for example, 18 FG signals for a single rotation, making use of, e.g. an electromotive force of a magnetic field coil of a stator or an output of a Hall element which detects the rotational angle of the magnet of a rotor.

A frequency divider 34 divides the FG signal that is output from the spindle motor 32, and generates an FG1 signal which indicates, for example, one rotation of the spindle motor 32. The frequency divider 34 outputs the FG1 signal to the controller 24. The controller 24 compares the FG1 signal with an internal reference frequency, controls a motor control circuit 30 in accordance with an error of the comparison result, and rotates the spindle motor 32 at a predetermined number of revolutions.

The controller 24 is configured to include processors and memories (RAM, ROM). The controller 24 causes the processors to execute various programs stored in the memories, thereby executing an overall control of the apparatus. The controller 24 includes a spindle motor rotation control unit 24a, a PUH movement control unit 24b, a laser control unit 24c, an eccentricity measuring unit 24d, a comparison unit 24e and a disk discrimination unit 24f.

The spindle motor rotation control unit 24a controls the rotation of the spindle motor 32 via the motor control circuit 30.

The PUH movement control unit 24b drives a thread motor 28 via a driver 26, thereby executing a control to move the pickup head 11 in the radial direction of the optical disk 10.

The laser control unit 24c controls the APC 36 and causes the laser diode of the pickup head 11 to emit a laser beam. The pickup head 11 is equipped with laser diodes for emitting an infrared laser beam for CD, a red laser beam for DVD and a blue laser beam for HD-DVD. The laser control unit 24c selects one of the laser beams and causes the pickup head 11 to emit it.

When the disk discrimination process for discriminating the kind of the optical disk 10 is executed, the eccentricity measuring unit 24d measures an eccentricity amount (eccentricity value) by detecting a variation in the PP signal which is generated from the head amplifier 14 by the push-pull method and a variation in the DPD signal which is generated by the phase difference method, in the state in which the position of the pickup head 11 is fixed. Specifically, the eccentricity measuring unit 24d measures an eccentricity amount by detecting, on the basis of variations of the signals, the number of tracks on the optical disk 10, over which the beam spot of the laser beam that is radiated from the pickup head 11 onto the optical disk 10 crosses.

The comparison unit 24e compares the eccentricity amount (eccentricity value), which is measured by the eccentricity measuring unit 24d, with a preset reference value, or with an eccentricity amount (eccentricity value) which is detected under a different condition. For example, the eccentricity amount (eccentricity value), which is detected under a different condition for the purpose of comparison, is an eccentricity amount (eccentricity value) which is detected at a different rotational speed of the spindle motor 32, or an eccentricity amount (eccentricity value) which is measured on the basis of each of the PP signal and DPD signal.

The disk discrimination unit 24f discriminates the kind of optical disk 10 on the basis of a comparison result of the comparison unit 24e.

The optical disk apparatus of this embodiment executes the disk discrimination process for discriminating the kind of optical disk 10 which is loaded. The disk discrimination process, which is described below, discriminates between the DVD and the HD-DVD. A detailed description of the discrimination process for CD-series disks is omitted, assuming that the CD-series disks are discriminated by a process different from the disk discrimination process for the DVD and HD-DVD in the present embodiment.

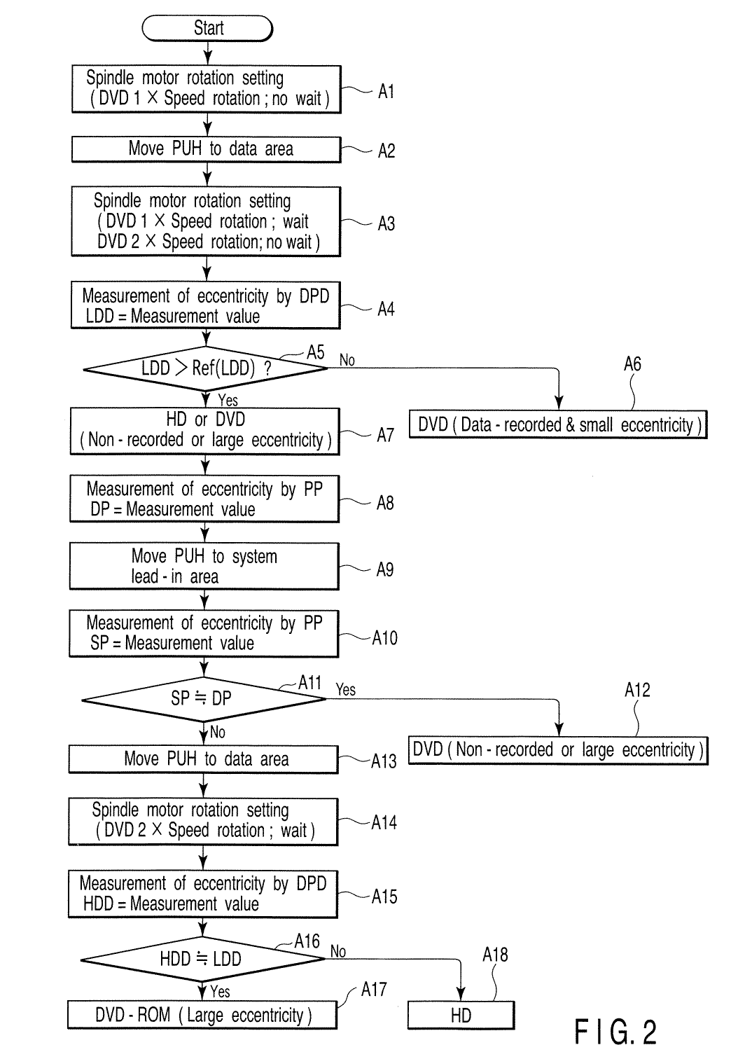

Next, referring to a flow chart of FIG. 2, a disk discrimination process (to be referred to as “first disk discrimination process”) according to the present embodiment is described.

To start with, if the controller 24 detects that the optical disk 10 is loaded on the spindle motor 32, the spindle motor rotation control unit 24a in the controller 24 executes spindle motor rotation setting in order to rotate the spindle motor 32 (step A1). The spindle motor rotation control unit 24a executes rotation setting for rotating the spindle motor 32, for example, at a 1× speed. The motor control circuit 30 starts driving the spindle motor 32 in accordance with the spindle motor rotation setting. In this case, the control goes to the next process step without waiting until the rotational speed of the spindle motor 32 reaches the 1× speed. In other words, immediately after the rotation setting is executed, the control advances to the next process step, thereby reducing the processing time for the disk discrimination.

During a time period before the rotational speed of the spindle motor 32 reaches the 1× speed, the PUH movement control unit 24b of the controller 24 drives the thread motor 28 via the driver 26 and moves the pickup head 11 to a data area of the optical disk 10 (step A2). The controller 24 executes a pre-focus-on process. Specifically, the laser control unit 24c causes, via the APC 36, the laser diode of the pickup head 11 to emit a red laser beam for DVD.

Then, the control waits until the rotational speed of the spindle motor 32 reaches the 1× speed. At the time the rotational speed of the spindle motor 32 reaches the 1× speed, the spindle motor rotation control unit 24a executes rotation setting for rotating the spindle motor 32, for example, at a 2× speed (step A3). The motor control circuit 30 starts driving the spindle motor 32 in accordance with the spindle rotation setting so that the rotational speed of the spindle motor 32 may reach the 2× speed. In this case, the control goes to the next process step without waiting until the rotational speed of the spindle motor 32 reaches the 2× speed. In other words, immediately after the rotation setting is executed, the control advances to the next process step, thereby reducing the processing time for the disk discrimination.

By waiting until the rotational speed of the spindle motor 32 reaches the 1× speed, the head amplifier 14 can generate a stable tracking error signal TE. In this case, the control waits until the rotational speed of the spindle motor 32 reaches the 1× speed in order to stably execute subsequent measurement of an eccentricity amount. However, if a focus error signal FE can stably be output from the head amplifier 14, the control may advance to the next process step when the rotational speed of the spindle motor 32 reaches a speed lower than the 1× speed, for instance, a 0.7× speed.

Subsequently, the controller 24 activates the servo amplifier 16 to focus the laser beam emitted from the objective lens 12 of the pickup head 11 on the optical disk 10. Specifically, the servo amplifier 16 controls the driver 20 in accordance with the focus error signal FE that is output from the head amplifier 14, causes the driver 20 to output a focus driving signal to the focusing actuator of the pickup head 11, and brings the laser beam emitted from the objective lens 12 of the pickup head 11 just in focus on the recording film of the optical disk 10. Thereby, a DPD signal, which is detected on the data area, can be made to have an amplitude which permits measurement of an eccentricity value.

The eccentricity measuring unit 24d measures the eccentricity amount (eccentricity value) of the optical disk 10 on the basis of the DPD signal that is output from the head amplifier 14 (step A4). Specifically, in the state in which the position of the pickup head 11 is being fixed, the eccentricity measuring unit 24d measures an eccentricity amount by detecting, on the basis of a variation of the signal, the number of tracks on the optical disk 10, over which the beam spot of the red laser beam that is radiated from the pickup head 11 onto the optical disk 10 crosses. For example, the number of tracks, over which the beam spot crosses during a single rotation of the optical disk 10, is set to be the eccentricity amount (for example, the number of tracks, over which the beam spot crosses during half the single rotation of the optical disk 10, may be set to be the eccentricity amount). The eccentricity measuring unit 24d stores the measured value as LDD.

Next, the comparison unit 24e compares the measurement value LDD, which is measured by the eccentricity measuring unit 24d, with a preset reference value Ref(LDD), and determines whether LDD>Ref(LDD), or not (step A5). The reference value Ref(LDD) is a reference value for discriminating a DVD having recorded data and a small eccentricity amount.

If the comparison unit 24e determines that the measurement value LDD is not greater than the reference value Ref(LDD) (No in step A5), that is, if the DPD signal is correctly generated, the disk discrimination unit 24f discriminates that the optical disk 10 loaded on the optical disk apparatus is a data-recorded DVD (including the case of a DVD-ROM) (step A6).

On the other hand, If the comparison unit 24e determines that the measurement value LDD is greater than the reference value Ref(LDD) (Yes in step A5), the disk discrimination unit 24f discriminates that the optical disk 10 loaded on the optical disk apparatus is probably an HD-DVD, or a data-non-recorded DVD or a DVD with a large eccentricity amount (step A7).

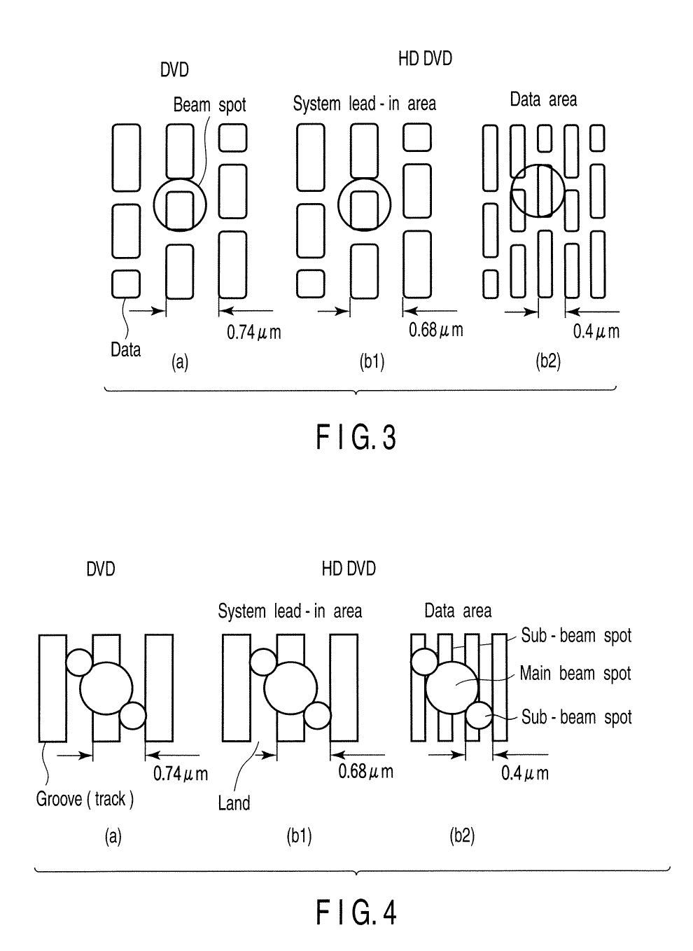

FIG. 3 is a view for explaining the generation of the DPD signal by the DPD method.

As is shown in part (a) of FIG. 3, the pitch of the track formed on the optical disk 10 that is the DVD is 0.74 μm. When a red laser beam is used, the beam spot does not cover, e.g. two or more tracks, as shown in part (a) of FIG. 3. Thus, when an eccentricity amount is measured on a data area of the DVD, a DPD signal which varies in accordance with the track on the optical disk 10 is generated.

As is shown in part (b1) and part (b2) of FIG. 3, the pitch of the track formed on the optical disk 10 that is the HD-DVD is 0.68 μm on a system lead-in area and is 0.4 μm on a data area which is provided radially outward of the system lead-in area.

As is shown in part (b1) of FIG. 3, when a red laser beam is used, the beam spot does not cover, e.g. two tracks on the system lead-in area of the HD-DVD, as in the case of the DVD. By contrast, as shown in part (b2) of FIG. 3, the beam spot covers two tracks on the data area of the HD-DVD. In the case where the beam spot is radiated so as to cover plural tracks, even if the DPD signal is generated on the basis of the reflective light from the optical disk 10, a normal tracking error signal TE is not produced. That is, the tracking error signal TE does not vary in accordance with the track formed on the optical disk 10, and a sharply varying noise signal is produced.

Thus, by setting the reference value Ref(LDD), which is to be compared with the measurement value LDD, at a value which permits discrimination of an eccentricity amount measured on the basis of the noise signal, it becomes possible to discriminate the data-recorded DVD (with a small eccentricity amount).

When it is determined in step A5 that the measurement value LDD is greater than the reference value Ref(LDD), there are two cases, as described above: a case in which the measurement value LDD becomes greater since the eccentric amount is measured based on the noise signal (the case of an HD-DVD or a data-non-recorded DVD), and a case in which the eccentric amount is actually large (the case of a data-recorded DVD). In a subsequent process, it is discriminated whether the loaded optical disk 10 is a DVD with a large eccentricity amount or an HD-DVD. In a special case of, e.g. a DVD-ROM which does not have a guide groove, it is possible that a PP signal (to be described later) is not normally produced and erroneous determination may be made. It is thus desirable to discriminate the DVD-ROM by using the determination in step A5. In addition, it is possible to discriminate the DVD-ROM by step A17 (to be described later).

For this purpose, an eccentricity amount is measured by using PP signals which are generated by the push-pull method on the data area and the system lead-in area of the optical disk 10. The PP signal is a signal that is normally generated if a guide groove is present on the track of the optical disk 10.

To start with, the eccentricity measuring unit 24d measures the eccentricity amount (eccentricity value) of the optical disk 10 on the basis of the PP signal output from the head amplifier 14, with respect to the current position of the pickup head 11, that is, the data area (step A8). The eccentricity measuring unit 24d stores the measured value as DP.

Next, the PUH movement control unit 24b moves the pickup head 11 to the system lead-in area of the optical disk 10 (step A9).

The eccentricity measuring unit 24d measures the eccentricity amount (eccentricity value) of the optical disk 10 on the basis of the PP signal output from the head amplifier 14, with respect to the system lead-in area of the optical disk 10 (step A10). The eccentricity measuring unit 24d stores the measured value as SP.

Subsequently, the comparison unit 24e determines whether the measurement value SP and the measurement value DP, which are measured with respect to the different areas on the optical disk 10, are substantially equal (step A11). For example, the comparison unit 24e determines that the measurement value SP and the measurement value DP are substantially equal, in the case where the condition of DP×0.9<SP<DP×1.1 (or SP×0.9<DP<SP×1.1) is satisfied.

In the above case, no consideration is given to the discrimination of a DVD-RAM. The track pitch of the DVD-RAM is not equal between an emboss area and a data area. Thus, if the tolerance range for determining that the measurement value SP and measurement value DP are substantially equal is narrowed, the DVD-RAM could not be determined to be a DVD. In order to determine in step A11 that the DVD-RAM is a DVD, the tolerance range is made wider than in the above-described condition. For example, in the case where the condition of DP×0.9<SP<DP×1.3 (or SP×0.7<DP<SP×1.1) is satisfied, the comparison unit 24e determines that the measurement value SP and the measurement value DP are substantially equal.

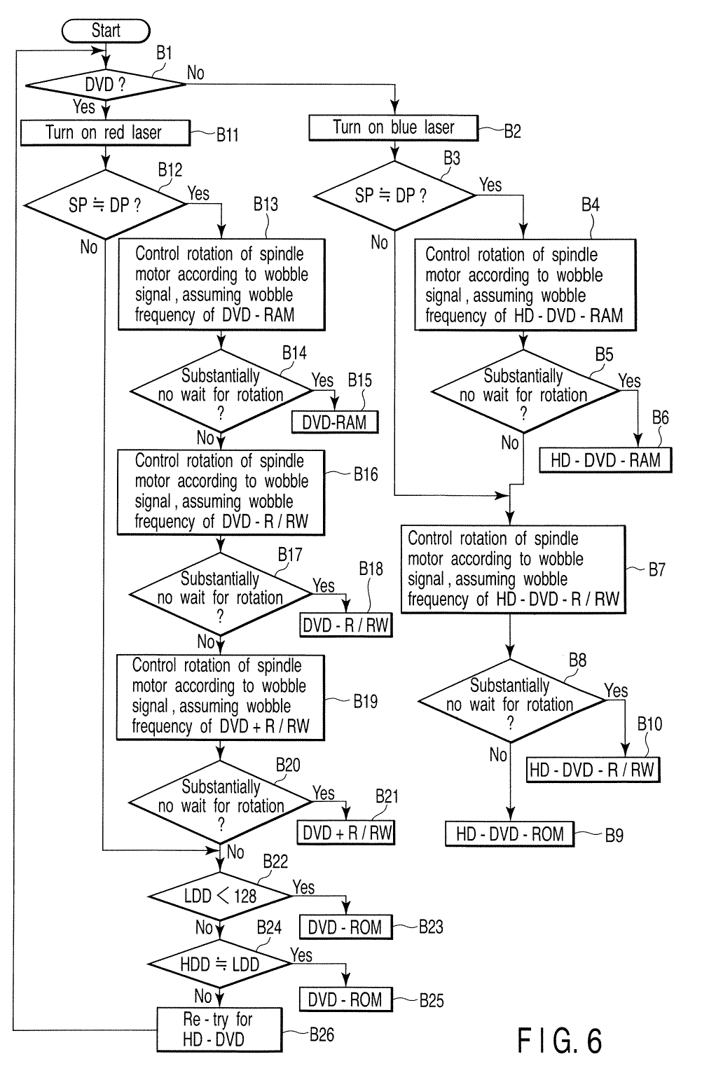

In the case of discriminating disks including the DVD-RAM by a disk discrimination process (second disk discrimination process) according to a flow chart of FIG. 6 (to be described later), it is determined, with a narrow tolerance range, whether the measurement value SP and the measurement value DP are substantially equal.

If the comparison unit 24e determines that the measurement value SP and the measurement value DP are substantially equal, the disk discrimination unit 24f determines that the loaded optical disk 10 is a DVD with a large eccentricity amount or a data-non-recorded DVD (step A12).

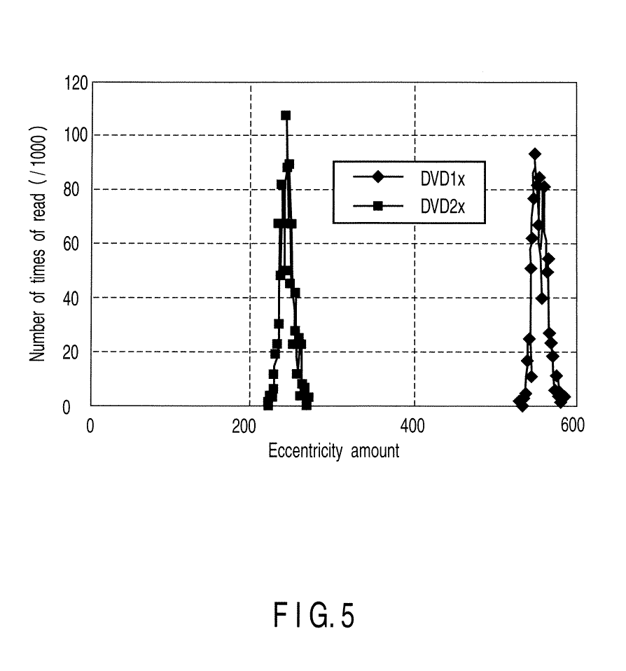

FIG. 4 is a view for explaining the generation of a DPP signal that is generated by a differential push-pull (DPP) method.

As is shown in part (a) and part (b1) of FIG. 4, when the DPP signal is used, a main beam spot does not cover two tracks formed on the optical disk 10 on the system lead-in area of the DVD or the HD-DVD. Thus, a DPP signal which varies in accordance with the track on the optical disk 10 is generated.

On the other hand, as is shown in part (b2) of FIG. 4, the main beam spot covers two tracks on the data area of the HD-DVD. In the case where the beam spot is radiated so as to cover plural tracks, a normal DPP signal is not produced, and a sharply varying noise signal is produced.

Thus, in the case where the measurement value SP and measurement value DP are substantially equal, the optical disk 10 can be determined to be a DVD with a large eccentricity amount or a data-non-recorded DVD.

By contrast, in the case where the measurement value SP and measurement value DP are not substantially equal, the optical disk 10 can be determined to be an HD-DVD which enables correct measurement of an eccentricity amount on the system lead-in area but disables correct measurement of an eccentricity amount on the data area.

As regards the DVD-ROM, however, the guide groove is not present on the track, as described above. It is thus possible that the PP signal cannot normally be read and the eccentricity amount cannot correctly be measured. In other words, the DVD-ROM may erroneously be determined to be an HD-DVD. In order to further enhance the reliability of the disk discrimination, the DVD-ROM and HD-DVD are discriminated on the basis of an eccentricity amount which is measured by the DPD signal in the state in which the number of revolutions of the optical disk 10 is different.

To begin with, if the comparison unit 24e determines that the measurement value SP and measurement value DP are not substantially equal (No in step All), the PUH movement control unit 24b moves the pickup head 11 to the data area of the optical disk 10 (step A13).

Then, the spindle motor rotation control unit 24a executes rotation setting for rotating the spindle motor 32, for example, at a 2× speed, and the control waits until the rotational speed of the spindle motor 32 reaches the 2× speed (step A14). However, if the rotational speed of the spindle motor 32 already reaches the 2× speed at this time point, re-setting of rotation is needless.

If the rotational speed of the spindle motor 32 reaches the 2× speed, the eccentricity measuring unit 24d measures the eccentricity amount (eccentricity value) of the optical disk 10 on the basis of the DPD signal that is output from the head amplifier 14 (step A15). Specifically, the eccentricity measuring unit 24d measures the number of times of signal variation which indicates that the beam spot of the red laser beam, which is radiated from the objective lens 12 of the pickup head 11 onto the optical disk 10, has crossed the track on the optical disk 10. In this case, for example, the number of times of signal variation, which is measured during a single rotation of the optical disk 10, is set to be the eccentricity amount. The eccentricity measuring unit 24d stores the measured value as HDD.

The eccentricity measuring unit 24d measures the variation of the tracking error signal TE at the same fixed sampling frequency (interval of measurement) as in the time period of the 1× speed, regardless of the rotational speed of the spindle motor 32. The eccentricity measuring unit 24d finds, as the eccentricity amount, a measurement value corresponding to a single rotation of the spindle motor 32.

The comparison unit 24e compares the measurement value LDD, which is measured when the rotational speed of the spindle motor 32 is the 1× speed, and the measurement value HDD which is measured at the time of the 2× speed (step A16). For example, the comparison unit 24e determines that the measurement value LDD and the measurement value HDD are substantially equal, in the case where the condition of LDD×0.8<HDD<LDD×1.2 (or HDD×0.8<LDD<HDD×1.2) is satisfied.

If the eccentricity measuring unit 24d determines that the measurement value HDD and the measurement value LDD are substantially equal, the disk discrimination unit 24f discriminates the DVD-ROM with a large eccentricity amount (step A17). Specifically, in the case where the measurement value HDD and the measurement value LDD are substantially equal, it is determined that the DPD signal is normally generated even with respect to the data area, and thus the DVD-ROM is discriminated.

On the other hand, if it is determined that the measurement value HDD and the measurement value LDD are not substantially equal, the disk discrimination unit 24f determines that the eccentricity amount is measured due to a noise signal and discriminates that the loaded optical disk 10 is the HD-DVD (step A18).

FIG. 5 is a view showing eccentricity amounts which are measured at different rotational speeds. FIG. 5 shows the eccentricity amounts measured by DPD signals which are generated when a red laser beam is used with respect to the data area of the HD-DVD. In this case, the DPD signal is not a signal varying in accordance with the track on the optical disk 10, but is a noise signal.

FIG. 5 shows the eccentricity amounts which are measured, respectively, when the rotational speed of the spindle motor 32 is at the 1× speed and at the 2× speed. At each rotational speed, the eccentricity amount was measured 1000 times and the degrees of the measured eccentricity amount were plotted on the graph.

As shown in FIG. 5, the eccentricity amount (right) measured at the time of the 1× speed is about 500, while the eccentricity amount (left) measured at the time of the 2× speed is about 250. The eccentricity amount is a measurement value that is measured during a single rotation of the optical disk 10. In the case where the eccentricity amount is measured as the number of times of crossing of the beam spot over the track (the number of tracks), the eccentricity amount is measured at a fixed sampling frequency (interval of measurement) regardless of the number of revolutions of the spindle motor 32.

Thus, in the case of a noise signal and not a normal DPD signal that varies when the beam spot crosses the track, the measurement value increases in proportion to the measurement time if the frequency of the noise signal becomes higher than the sampling frequency. Accordingly, as shown in FIG. 5, the eccentricity amount (the number of times of variation of the signal) per single rotation, which is measured at the time of the 2× speed rotation, is about half the measurement value at the time of the 1× speed rotation.

If the eccentricity amount at the time of the 1× speed rotation and the eccentricity amount at the time of the 2× speed rotation, which are measured by the DPD method, are compared and are determined to be substantially equal, the eccentricity amount is exactly measured and, as shown in part (a) of FIG. 3, a DVD (data-recorded disk), on which the red laser beam spot does not cover two tracks, can be discriminated. If both eccentricity amounts are not substantially equal, an HD-DVD or a DVD (non-recorded), as shown in part (b2) of FIG. 3, on which the red laser beam spot covers two tracks, can be discriminated.

As has been described above, in the first disk discrimination process of the present embodiment, the eccentricity amount (the number of tracks crossed by the tracking signal during a single rotation of the optical disk 10) is measured by the DPD signal with respect to the data area. If the measured eccentricity amount is not greater than the reference value Ref(LDD), the DPD signal is normally generated and the DVD (data-recorded disk) with a small eccentricity amount is discriminated. If the eccentricity amount is greater than the reference value Ref(LDD), the DPD signal is not normally generated and a noise signal is generated, and thus the HD-DVD is discriminated. In this case, however, it is possible that the optical disk is a DVD with a large eccentricity amount or a data-non-recorded DVD.

Further, the eccentricity amount on the system lead-in area and the eccentricity amount on the data area are measured using the DPP signal, and are compared. If both eccentricity amounts are substantially equal, a DVD, on which the track pitch of the system lead-in area is equal to the track pitch of the data area, can be discriminated. If both eccentricity amounts are not substantially equal, the HD-DVD can be discriminated.

It should be noted, however, that in the case of, e.g. the DVD-ROM, no guide groove is provided on the track, and thus the DPP signal may not normally be read and the eccentricity amount may become an erroneous value.

To cope with this, the rotational speed of the optical disk is increased (e.g. 2× speed) and the eccentricity amount on the data area is measured by the DPD signal once again. The measured eccentricity amount is compared with the eccentricity amount that was measured before the rotational speed was increased (e.g. at the time of 1× speed). If the eccentricity amounts, which are measured at different rotational speeds, are substantially equal, it is determined that the DPD signal is normally generated, and the DVD-ROM (with a large eccentricity amount) is discriminated. If the eccentricity amounts are not substantially equal, the HD-DVD is discriminated.

In this manner, making use of the process of measuring the eccentricity amount of the optical disk, HD-DVD and DVD can be discriminated. In the first disk discrimination process according to the embodiment, there is no need to execute a process of reading data recorded on the optical disk. Moreover, a re-try operation for confirming whether the data read is possible or not is unnecessary. Therefore, the optical disk can quickly be discriminated.

In the meantime, in the first disk discrimination process, the DVD and HD-DVD are discriminated, taking advantage of the fact that the track pitch is different between the system lead-in area and the data area of the HD-DVD, as shown in parts (b1) and (b2) of FIG. 3 and FIG. 4. However, in the case of the HD-DVD-RAM, the track pitch is equal between the system lead-in area and the data area. Thus, in the first disk discrimination process, the HD-DVD-RAM may possibly be determined to be a DVD. As regards HD-DVD-series disks, other than the HD-DVD-RAM, they may erroneously be discriminated as DVDs in the case where the eccentricity amounts measured on the system lead-in area and the data area are substantially equal.

To solve this problem, a second disk discrimination process, which will be described below, is executed to discriminate various disks including the HD-DVD-RAM.

Next, the second disk discrimination process for discriminating disks including the HD-DVD-RAM is described with reference to a flow chart of FIG. 6.

In the second disk discrimination process, in addition to the measured result of the eccentricity amount, the wobble formed in the guide groove of a recordable medium is utilized to discriminate the kind of the optical disk. It is thus assumed that in order to discriminate the DVD-ROM disk on which neither the guide groove or wobble is formed, the process in the flow chart of FIG. 2, which measures the eccentricities by the DPD signal at different rotational speeds (1× speed and 2× speed), has already been executed. Specifically, in the flow chart of FIG. 2, even if the optical disk is discriminated as the DVD in step A6, A12, the process of step A14, A15 is executed.

If the kind of the optical disk is discriminated as the DVD in the first disk discrimination process (Yes in step B1), the laser control unit 24c causes, via the APC 36, the laser diode of the pickup head 11 to emit a red laser beam for DVD (step B11).

The comparison unit 24e determines whether the measurement value SP and the measurement value DP, which are measured in the first disk discrimination process, are substantially equal (step B12). For example, the comparison unit 24e determines that the measurement value SP and the measurement value DP are substantially equal, in the case where the condition of DP×0.9<SP<DP×1.3 (or SP×0.7<DP<SP×1.1) is satisfied. In this case, in order to discriminate the DVD-RAM to be a DVD, the tolerance range for determining that the measurement value SP and the measurement value DP are substantially equal is made wider than in step A11.

If it is determined that the measurement value SP and measurement value DP are not substantially equal (No in step B12), the control goes to a process for discriminating a DVD-ROM (step B22). This process will be described later.

On the other hand, if it is determined that the measurement value SP and measurement value DP are substantially equal (Yes in step B12), the spindle motor rotation control unit 24a controls, via the motor control circuit 30, the rotation of the spindle motor 32 in accordance with a wobble signal which is output from the head amplifier 14.

The wobble signal is a signal that is output in accordance with the wobble shape formed on the groove of the optical disk, that is, so-called “wobble”. The wobble signal is formed with a fixed frequency, and the frequency (wobble frequency) is varies in accordance with the kind of the optical disk. The second disk discrimination process takes advantage of the fact that the wobble frequency varies in accordance with the kind of the optical disk. Specifically, assuming a certain kind of the optical disk, the rotation of the spindle motor 32 is controlled to have a preset speed on the basis of the wobble signal that is detected from this optical disk. If the rotational speed reaches the number of revolutions of the preset speed in a short time period (if the rotation is locked), the assumed the optical disk is discriminated.

To begin with, the spindle motor rotation control unit 24a executes rotational speed setting for controlling the rotational speed of the spindle motor 32 on the basis of the FG1 signal output from the frequency divider 34, and also executes rotational speed setting for controlling the rotational speed of the spindle motor 32 on the basis of the wobble signal. In this case, it is assumed that the rotational speed setting is executed to rotate the spindle motor 32 at substantially the same speed, for example, at the 2× speed. In the meantime, the FG1 signal is a signal that is generated from the frequency divider 34 on the basis of the FG signal output from the spindle motor 32 (i.e. a predetermined number of signals output from the spindle motor 32 during one rotation).

To begin with, the spindle motor rotation control unit 24a controls the rotation of the spindle motor 32 on the basis of the FG1 signal so that the rotational speed may reach the preset speed (2× speed). In the description below, this rotation control is referred to as “FG rotation”.

Subsequently, assuming that the optical disk is the DVD-RAM, the spindle motor rotation control unit 24a controls the rotation of the spindle motor 32 by wobble rotation so that the rotational speed may reach the preset speed (2× speed) (step B13). In the description below, this rotation control is referred to as “wobble rotation”.

When the FG rotation is switched to the wobble rotation, if the rotational speed reaches the number of revolutions of the preset speed (2× speed) in a short time period (i.e. if the rotation is locked) (Yes in step B14), the disk discrimination unit 24f discriminates the assumed DVD-RAM (step B15).

On the other hand, if the rotation is not locked in a short time period (No in step B14), a optical disk other than the assumed DVD-RAM is discriminated and the control advances to a process assuming another kind of the optical disk.

Similarly with the above, the spindle motor 32 is rotated by the FG rotation at the preset speed and then, assuming that the optical disk is the DVD-R/RW, the rotation of the spindle motor 32 is controlled by the wobble rotation so that the rotational speed may reach the preset speed (2× speed) (step B16).

When the FG rotation is switched to the wobble rotation, if the rotational speed reaches the number of revolutions of the preset speed (2× speed) in a short time period (i.e. if the rotation is locked) (Yes in step B17), the disk discrimination unit 24f discriminates the assumed DVD-R/RW (step B18).

On the other hand, if the rotation is not locked in a short time period (No in step B17), a optical disk other than the assumed DVD-R/RW is discriminated and the control advances to a process assuming another kind of the optical disk.

Similarly, the spindle motor 32 is rotated by the FG rotation at the preset speed and then, assuming that the optical disk is the DVD+R/RW, the rotation of the spindle motor 32 is controlled by the wobble rotation so that the rotational speed may reach the preset speed (2× speed) (step B19).

When the FG rotation is switched to the wobble rotation, if the rotational speed reaches the number of revolutions of the preset speed (2× speed) in a short time period (i.e. if the rotation is locked) (Yes in step B20), the disk discrimination unit 24f discriminates the assumed DVD+R/RW (step B21).

On the other hand, if the rotation is not locked in a short time period (No in step B20), a optical disk other than the assumed DVD+R/RW is discriminated and the control advances to a process assuming another kind of the optical disk.

In this process, it is determined whether the optical disk is the DVD-ROM or not. If it is determined that data is recorded on the optical disk, the optical disk is discriminated to be the DVD-ROM.

To begin with, the comparison unit 24e compares the LDD, which indicates the eccentricity amount measured by the first disk discrimination process, with a preset reference value, for example, a value “128” for discriminating a sufficiently small value.

If the comparison result shows that the measurement value LDD is smaller than the reference value “128” (Yes in step B22), the disk discrimination unit 24f can discriminate that the measurement value is the eccentricity amount measured in accordance with the track formed on the optical disk and that data is recorded on the optical disk. That is, the disk discrimination unit 24f discriminates the optical disk to be the DVD-ROM (step B23).

If the comparison result shows that the measurement value LDD is not smaller than the reference value “128”, the comparison unit 24e determines whether the measurement value HDD and the comparison value LDD, which are measured in the first disk discrimination process, are substantially equal. For example, the comparison unit 24e determines that the measurement value LDD and the measurement value HDD are substantially equal, in the case where the condition of LDD×0.8<HDD<LDD×1.2 (or HDD×0.8<LDD<HDD×1.2) is satisfied.

If it is determined that the measurement value HDD and the measurement value LDD are substantially equal (Yes in step B24), the disk discrimination unit 24f determines that the DPD signal is normally generated from the lead-in area and data area and discriminates the DVD-ROM on which data is recorded (step B25).

On the other hand, if it is determined that the measurement value HDD and the measurement value LDD are not substantially equal (No in step B24), it is possible that the loaded the optical disk is not a DVD-series disk but an HD-DVD-series disk. Thus, the control goes to a process for discriminating the HD-DVD-series disk (step B26).

In the case where the loaded the optical disk is not discriminated to be the DVD-series disk in the process of steps B12 to B25 or in the case where the kind of the optical disk is discriminated to be the HD-DVD in the first disk discrimination process (No in step B1), the laser control unit 24c causes, via the APC 36, the laser diode of the pickup head 11 to emit a blue laser beam for HD-DVD (step B2).

The comparison unit 24e determines whether the measurement value SP and the measurement value DP, which are measured in the first disk discrimination process using blue laser beam, are substantially equal (step B3). For example, the comparison unit 24e determines that the measurement value SP and the measurement value DP are substantially equal, in the case where the condition of DP×0.9<SP<DP×1.1 (or SP×0.9<DP<SP×1.1) is satisfied.

If it is determined that the measurement value SP and measurement value DP are substantially equal (Yes in step B3), the spindle motor rotation control unit 24a controls, via the motor control circuit 30, the rotation of the spindle motor 32 in accordance with a wobble signal which is output from the head amplifier 14.

To begin with, the spindle motor rotation control unit 24a controls the rotation of the spindle motor 32 on the basis of the FG1 signal so that the rotational speed may reach the preset speed (2× speed).

Subsequently, assuming that the optical disk is an HD-DVD-RAM, the spindle motor rotation control unit 24a controls the rotation of the spindle motor 32 by the wobble rotation so that the rotational speed may reach the preset speed (2× speed) (step B4).

When the FG rotation is switched to the wobble rotation, if the rotational speed reaches the number of revolutions of the preset speed (2× speed) in a short time period (i.e. if the rotation is locked) (Yes in step B5), the disk discrimination unit 24f discriminates the assumed HD-DVD-RAM (step B6).

On the other hand, if the rotation is not locked in a short time period (No in step B5), a optical disk other than the assumed HD-DVD-RAM is discriminated and the control advances to a process assuming another kind of the optical disk.

Similarly with the above, the spindle motor 32 is rotated by the FG rotation at the preset speed and then, assuming that the optical disk is an HD-DVD-R/RW, the rotation of the spindle motor 32 is controlled by the wobble rotation so that the rotational speed may reach the preset speed (2× speed) (step B7).

When the FG rotation is switched to the wobble rotation, if the rotational speed reaches the number of revolutions of the preset speed (2× speed) in a short time period (i.e. if the rotation is locked) (Yes in step B8), the disk discrimination unit 24f discriminates the assumed HD-DVD-R/RW (step B10).

On the other hand, if the rotation is not locked in a short time period (No in step B8), the disk discrimination unit 24f discriminates the HD-DVD-ROM (step B9).

As described above, the respective DVD-series disks (DVD-RAM, DVD-R/RW, DVD+R/RW) are assumed, and also wobble frequencies of these optical disks are assumed. In accordance with the wobble signal detected from the optical disk, the rotation of the spindle motor 32 is controlled. If the rotation is locked in a short time period, the assumed disk is discriminated. If the rotation is not locked in a short time period even when each of the kinds of the optical disks is assumed, it is then determined whether the optical disk is a DVD-ROM or not (i.e. whether data is recorded or not). If the determination result shows that the optical disk is not the DVD-ROM, the loaded the optical disk is discriminated to be not the DVD-series disk. In the case where this process is executed, even if the HD-DVD-RAM was determined to be a DVD in the first disk discrimination process, the HD-DVD-RAM is determined to be not the DVD in the second disk discrimination process. In this case, since the optical disk discrimination using the blue laser is executed, the HD-DVD-series disk can be discriminated.

As regards the HD-DVD-series disks, too, the wobble frequency of each optical disk (HD-DVD-RAM, HD-DVD-R/RW) is assumed and the wobble rotation is executed. If the rotation is locked in a short time period, it can be determined that the loaded the optical disk is a disk on which the wobble is formed according to the wobble frequency. Therefore, the optical disk discrimination can quickly be executed.

In this manner, according to the second disk discrimination process, the kinds of the optical disks including the HD-DVD-RAM can be discriminated on the basis of not only the measurement values of the eccentricity amounts used in the first disk discrimination process, but also the result of the optical disk rotation control using the wobble signal that is output in accordance with the wobble formed on the optical disk. In the optical disk discrimination using the wobble signal, as described above, it is determined whether the rotation is locked in a short time period. If the rotation is not locked in a short time period, the control can immediately go to the optical disk discrimination process for another kind of the optical disk. Therefore, the kind of the optical disk can quickly be executed.

In the above-described first disk discrimination process, the eccentricity amounts are measured with respect to the data area and system lead-in area. However, the eccentricity amounts may be measured with respect to other areas if the eccentricity amounts are measured with respect to a plurality of areas having different track pitches. For example, the eccentricity amount may be measured with respect to a system lead-out area in place of the system lead-in area. On the areas other than the system lead-in area and system lead-out area, the track pitch is equal to that of the data area. Thus, instead of the data area, an area other than the system lead-in area and system lead-out area may be used for measuring the eccentricity amount.

In the first disk discrimination process, the DPD signal or PP signal is used when the eccentricity amount is measured. Alternatively, the eccentricity amount may be measured by using the RF signal in place of the PP signal or DPD signal.

In the first disk discrimination process, the eccentricity amounts are measured with respect to the system lead-in area and the data area, and the measured values are compared to discriminate the optical disk (step A11). Alternatively, the optical disk discrimination may be executed using another measurement value that is obtained at the time of the operation of measuring the eccentricity amount. For example, the optical disk discrimination may be executed on the basis of a gain value of the tracking error signal TE that is generated by the head amplifier 14 at the time of the operation of measuring the eccentricity amount. In this case, the gain is adjusted so that the amplitude of the tracking error signal TE, which is generated by the head amplifier 14, may have a predetermined value. In addition, eccentricity amounts are measured with respect to the system lead-in area and data area, and the gain amplification factors of the associated tracking error signals are detected. A difference between the gain amplification factors, which are obtained with respect to the system lead-in area and data area, is detected. If the difference is small, it is determined that not a noise signal but a signal varying in accordance with the track on the optical disk 10 (i.e. a signal that is varied by crossing over the track) is produced, and the loaded the optical disk is discriminated to be the DVD. If the difference between the gain amplification factors is large, the HD-DVD is discriminated.

Thereby, it is possible to determine whether the tracking error signal TE generated by the head amplifier represents a noise signal or a large eccentricity amount.

In the above-described first disk discrimination process, the eccentricity amount is measured using the red laser. Alternatively, the blue laser for HD-DVD may be used to measure the eccentricity amount. In the case where the eccentricity amount is measured using the red laser, if the eccentricity amount is measured by the PP signal with respect to the data area of the HD-DVD, the normal PP signal is not produced. Consequently, the eccentricity amount, which is measured with respect to the data area, may possibly be determined to be equal to the eccentricity amount measured with respect to the system lead-in area, and the loaded the optical disk may erroneously be discriminated to be the DVD. Thus, when the eccentricity amount is measured by the PP signal with respect to the data area, specifically, in step A8 in the flow chart of FIG. 2, a blue laser beam is emitted from the pickup head 11 to normally measure the eccentricity amount. Thereby, the measurement value DP measured on the data area and the measurement value SP measured on the system lead-in area can exactly be compared (step A11), and the optical disk can be discriminated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the apparatus comprising:
a motor which rotates the optical disk that is loaded at one of a first rotation speed and a second rotation speed which is twice or more higher than the first rotation speed;
a pickup head which radiates one of a first DVD laser beam and a second DVD laser beam to the optical disk via an objective lens, and receives reflective light from the optical disk;
a movement mechanism which moves the pickup head in a radial direction of the optical disk;
a head amplifier which receives the reflective light from the pickup head, and outputs at least a focus error signal, a first tracking error signal by a DPD method, and a second tracking error signal by a PP method;
a driving mechanism which drives the pickup head on the basis of the focus error signal, and one of the first and second tracking error signals, thereby executing a focus ON control and a track positioning control; and
a controller which controls the motor, the pickup head, the movement mechanism, the head amplifier and the driving mechanism,
wherein the controller controls the movement mechanism to move the pickup head to a data area of the optical disk, while controlling the motor to rotate the optical disk at the first rotation speed,
controls the pickup head to radiate the first DVD laser beam to the optical disk,
measures, as a first eccentricity amount, a number of beams, which have crossed a track on the optical disk during rotation of the optical disk, from the first tracking error signal which is output from the head amplifier,
compares the measured first eccentricity amount with a predetermined reference value, and
determines that the loaded optical disk is a data-recorded said first DVD optical in a case where the first eccentricity amount is less than the reference value, and determines that the loaded optical disk is the second DVD optical disk or the first DVD optical disk with a large eccentricity amount in a case where the first eccentricity amount is greater than the reference value.

2. The optical disk apparatus according to claim 1, wherein the controller further measures, as a second eccentricity amount, a number of beams which have crossed the track on the data area of the optical disk, with respect to which it has been determined that the first eccentricity amount is greater than the reference value, during rotation of the optical disk, from the second tracking error signal which is output from the head amplifier,
controls the movement mechanism to move the pickup head to a system lead-in area of the optical disk,
measures, as a third eccentricity amount, a number of beams, which have crossed a track on the system lead-in area of the optical disk during rotation of the optical disk, from the second tracking error signal which is output from the head amplifier,
compares the second eccentricity amount and the third eccentricity amount, and
determines that the loaded optical disk is a non-data-recorded said first DVD optical disk or the first DVD optical disk with a large eccentricity amount in a case where it is determined that the second eccentricity amount is approximately equal to the third eccentricity amount.

3. The optical disk apparatus according to claim 2, wherein the controller further moves the pickup head to the data area of the optical disk with respect to which it has been determined that the second eccentricity amount is not approximately equal to the third eccentricity amount,
controls the motor to rotate the optical disk at the second rotation speed,
measures, as a fourth eccentricity amount, a number of beams, which have crossed the track on the data area of the optical disk during rotation of the optical disk, from the first tracking error signal which is output from the head amplifier,
compares the fourth eccentricity amount and the first eccentricity amount, and
determines that the loaded optical disk is the first DVD disk with the large eccentricity amount in a case where it is determined that the fourth eccentricity amount is approximately equal to the first eccentricity amount, and determines that the loaded optical disk is the second DVD disk in a case where it is determined that the fourth eccentricity amount is not approximately equal to the first eccentricity amount.

4. The optical disk apparatus according to claim 3, wherein the first DVD optical disk with the large eccentricity amount is a DVD-ROM.

5. The optical disk apparatus according to claim 1, wherein the reference value is a value for discriminating a sharply varying noise signal.

6. An optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the apparatus comprising:
a motor which rotates the optical disk that is loaded at one of a first rotation speed and a second rotation speed which is twice or more higher than the first rotation speed;
a pickup head which radiates one of a first DVD laser beam and a second DVD laser beam to the optical disk via an objective lens, and receives reflective light from the optical disk;
a movement mechanism which moves the pickup head in a radial direction of the optical disk;
a head amplifier which receives the reflective light from the pickup head, and outputs at least a focus error signal, a first tracking error signal by a DPD method, a second tracking error signal by a PP method, and a wobble signal;
a driving mechanism which drives the pickup head on the basis of the focus error signal, and one of the first and second tracking error signals, thereby executing a focus ON control and a track positioning control; and
a controller which controls the motor, the pickup head, the movement mechanism, the head amplifier and the driving mechanism,
wherein the controller radiates the first DVD laser beam to a data area of the optical disk from the pickup head,
rotates the optical disk at the first rotation speed, and measures, as a first eccentricity amount, a number of beams, which have crossed a track on the data area of the optical disk, from the first tracking error signal which is output from the head amplifier,
rotates the optical disk at the second rotation speed, and measures, as a second eccentricity amount, a number of beams, which have crossed the track on the data area of the optical disk, from the first tracking error signal which is output from the head amplifier,
measures, as a third eccentricity amount, a number of beams, which have crossed the track on the data area of the optical disk, from the second tracking error signal which is output from the head amplifier, in a case where it is determined that the first eccentricity amount is approximately equal to the second eccentricity amount and thus that the optical disk is the first DVD optical disk,
moves the pickup head to a system lead-in area of the optical disk, and measures, as a fourth eccentricity amount, a number of beams, which have crossed a track on the system lead-in area of the optical disk, from the second tracking error signal which is output from the head amplifier,
executes a rotation control to set the rotation speed of the motor at one of at least first to third preset speeds on the basis of the wobble signal that is output from the head amplifier, in a case where it is determined that the third eccentricity amount is approximately equal to the fourth eccentricity amount, and
determines that the optical disk is one of the first DVD optical disks which are assumed by the first to third preset speeds, in a case where the rotation speed of the motor has reached one of the first to third preset speeds in a short time.

7. The optical disk apparatus according to claim 6, wherein the first preset speed is determined on an assumption of a DVD-RAM disk, the second preset speed is determined on an assumption of a DVD-R disk or a DVD-RW disk, and the third preset speed is determined on an assumption of a DVD+R disk or a DVD+RW disk.

8. The optical disk apparatus according to claim 6, wherein the controller further determines that the optical disk that is loaded is a DVD-ROM disk in a case where the rotation speed of the motor fails to reach any one of the first to third preset speeds in a short time and it is determined that the first eccentricity amount is greater than a second reference value or that the first eccentricity amount is approximately equal to the second eccentricity amount.

9. An optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the apparatus comprising:
a motor which rotates the optical disk that is loaded at one of a first rotation speed and a second rotation speed which is twice or more higher than the first rotation speed;
a pickup head which radiates one of a first DVD laser beam and a second DVD laser beam to the optical disk via an objective lens, and receives reflective light from the optical disk;
a movement mechanism which moves the pickup head in a radial direction of the optical disk;
a head amplifier which receives the reflective light from the pickup head, and outputs at least a focus error signal, a first tracking error signal by a DPD method, a second tracking error signal by a PP method, and a wobble signal;
a driving mechanism which drives the pickup head on the basis of the focus error signal, and one of the first and second tracking error signals, thereby executing a focus ON control and a track positioning control; and
a controller which controls the motor, the pickup head, the movement mechanism, the head amplifier and the driving mechanism,
wherein the controller radiates the first DVD laser beam to a data area of the optical disk from the pickup head,
rotates the optical disk at the first rotation speed, and measures, as a first eccentricity amount, a number of beams, which have crossed a track on the data area of the optical disk, from the first tracking error signal which is output from the head amplifier,
rotates the optical disk at the second rotation speed, and measures, as a second eccentricity amount, a number of beams, which have crossed the track on the data area of the optical disk, from the first tracking error signal which is output from the head amplifier,
radiates the second DVD laser beam to the data area and a system lead-in area of the optical disk from the pickup head in a case where it is determined that the first eccentricity amount is not approximately equal to the second eccentricity amount and thus that the optical disk is the second DVD optical disk,
measures, as a third eccentricity amount, a number of beams, which have crossed the track on the data area of the optical disk, from the second tracking error signal which is output from the head amplifier,
measures, as a fourth eccentricity amount, a number of beams, which have crossed a track on the system lead-in area of the optical disk, from the second tracking error signal which is output from the head amplifier,
executes a rotation control to set the rotation speed of the motor at one of at least fourth and fifth preset speeds on the basis of the wobble signal that is output from the head amplifier, in a case where it is determined that the third eccentricity amount is approximately equal to the fourth eccentricity amount, and
determines that the optical disk is one of the second DVD optical disks which are assumed by the fourth and fifth preset speeds, in a case where the rotation speed of the motor has reached one of the fourth and fifth preset speeds in a short time.

10. The optical disk apparatus according to claim 9, wherein the fourth preset speed is determined on an assumption of an HD-DVD-RAM disk and the fifth preset speed is determined on an assumption of an HD-DVD-R disk or an HD-DVD-RW disk.

11. The optical disk apparatus according to claim 9, wherein the controller determines that the optical disk that is loaded is an HD-DVD-ROM disk in a case where the rotation speed of the motor fails to reach any one of the fourth and fifth preset speeds in a short time.

12. A disk discrimination method for an optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the method comprising:
moving a pickup head to a data area of the optical disk while rotating the optical disk, which is loaded, at a first rotation speed;
radiating a first DVD laser beam to the optical disk from the pickup head;
measuring, as a first eccentricity amount, a number of beams, which have crossed a track on the data area of the optical disk during rotation of the optical disk, from a first tracking error signal which is based on a DPD method and is output from a head amplifier which receives reflective light from the optical disk;
comparing the measured first eccentricity amount with a predetermined reference value; and
determining that the loaded optical disk is a data-recorded said first DVD optical in a case where the first eccentricity amount is less than the reference value, and determining that the loaded optical disk is the second DVD optical disk or the first DVD optical disk with a large eccentricity amount in a case where the first eccentricity amount is greater than the reference value.

13. The disk discrimination method according to claim 12, further comprising:
measuring, when it has been determined that the first eccentricity amount is greater than the reference value, a number of beams, which have crossed the track on the data area of the optical disk, as a second eccentricity amount, during rotation of the optical disk, from a second tracking error signal which is based on a PP method and is output from the head amplifier;
moving the pickup head to a system lead-in area of the optical disk, and measuring, as a third eccentricity amount, a number of beams, which have crossed a track on the system lead-in area of the optical disk during rotation of the optical disk, from the second tracking error signal which is output from the head amplifier;
comparing the second eccentricity amount and the third eccentricity amount; and
determining that the loaded optical disk is a non-data-recorded said first DVD optical disk or the first DVD optical disk with a large eccentricity amount in a case where it is determined that the second eccentricity amount is approximately equal to the third eccentricity amount.

14. The disk discrimination method according to claim 13, further comprising:
moving the pickup head to the data area of the optical disk when it is determined that the second eccentricity amount is not approximately equal to the third eccentricity amount;
rotating the optical disk at a second rotation speed which is twice or more higher than the first rotation speed;
measuring, as a fourth eccentricity amount, a number of beams, which have crossed the track on the data area of the optical disk during rotation of the optical disk, from the first tracking error signal which is output from the head amplifier;
comparing the fourth eccentricity amount and the first eccentricity amount; and
determining that the loaded optical disk is the first DVD disk with the large eccentricity amount in a case where it is determined that the fourth eccentricity amount is approximately equal to the first eccentricity amount, and determining that the loaded optical disk is the second DVD disk in a case where it is determined that the fourth eccentricity amount is not approximately equal to the first eccentricity amount.

15. A disk discrimination method for an optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the method comprising:
moving a pickup head to a data area of the optical disk while rotating the optical disk, which is loaded, at a first rotation speed;
radiating a first DVD laser beam to the optical disk from the pickup head;
measuring, as a first eccentricity amount, a number of beams, which have crossed a track on the data area of the optical disk, from a first tracking error signal which is based on a DPD method and is output from a head amplifier which receives reflective light from the optical disk;
rotating the optical disk at a second rotation speed which is twice or more higher than the first rotation speed;
measuring, as a second eccentricity amount, a number of beams, which have crossed the track on the data area of the optical disk, from the first tracking error signal which is output from the head amplifier;
measuring, as a third eccentricity amount, a number of beams, which have crossed the track on the data area of the optical disk, from a second tracking error signal which is based on a PP method and is output from the head amplifier, in a case where it is determined that the first eccentricity amount is approximately equal to the second eccentricity amount and thus that the optical disk is the first DVD optical disk;
moving the pickup head to a system lead-in area of the optical disk, and measuring, as a fourth eccentricity amount, a number of beams, which have crossed a track on the system lead-in area of the optical disk, from the second tracking error signal which is output from the head amplifier;
executing a rotation control to set the rotation speed of the motor at one of at least first to third preset speeds on the basis of a wobble signal that is output from the head amplifier, in a case where it is determined that the third eccentricity amount is approximately equal to the fourth eccentricity amount; and
determining that the optical disk is one of the first DVD optical disks which are assumed by the first to third preset speeds, in a case where the rotation speed of the motor has reached one of the first to third preset speeds in a short time.

16. The disk discrimination method according to claim 15, wherein the first preset speed is determined on an assumption of a DVD-RAM disk, the second preset speed is determined on an assumption of a DVD-R disk or a DVD-RW disk, and the third preset speed is determined on an assumption of a DVD+R disk or a DVD+RW disk.

17. The disk discrimination method according to claim 16, wherein it is determined that the optical disk that is loaded is a DVD-ROM disk in a case where the rotation speed of the motor fails to reach any one of the first to third preset speeds in a short time and it is determined that the first eccentricity amount is greater than a second reference value or that the first eccentricity amount is approximately equal to the second eccentricity amount.

18. A disk discrimination method for an optical disk apparatus in which one of a first DVD optical disk and a second optical DVD optical disk is loadable, there being at least a plurality of kinds of said first DVD optical disks and at least a plurality of kinds of said second DVD optical disks, the second DVD optical disk having a smaller track width than the first DVD optical disk, the method comprising:
moving a pickup head to a data area of the optical disk while rotating the optical disk, which is loaded, at a first rotation speed;
radiating a first DVD laser beam to the optical disk from the pickup head;
measuring, as a first eccentricity amount, a number of beams, which have crossed a track on the data area of the optical disk, from a first tracking error signal which is based on a DPD method and is output from a head amplifier which receives reflective light from the optical disk;
rotating the optical disk at a second rotation speed which is twice or more higher than the first rotation speed, and measuring, as a second eccentricity amount, a number of beams, which have crossed the track on the data area of the optical disk, from the first tracking error signal which is output from the head amplifier;
radiating a second DVD laser beam to the data area and a system lead-in area of the optical disk from the pickup head in a case where it is determined that the first eccentricity amount is not approximately equal to the second eccentricity amount and thus that the optical disk is the second DVD optical disk;
measuring, as a third eccentricity amount, a number of beams, which have crossed the track on the data area of the optical disk, from the second tracking error signal which is output from the head amplifier at a time when the head amplifier receives the reflective light from the data area;
measuring, as a fourth eccentricity amount, a number of beams, which have crossed a track on the system lead-in area of the optical disk, from the second tracking error signal which is output from the head amplifier at a time when the head amplifier receives the reflective light from the system lead-in area;
executing a rotation control to set the rotation speed of the motor at one of at least fourth and fifth preset speeds on the basis of a wobble signal that is output from the head amplifier, in a case where it is determined that the third eccentricity amount is approximately equal to the fourth eccentricity amount; and
determining that the optical disk is one of the second DVD optical disks which are assumed by the fourth and fifth preset speeds, in a case where the rotation speed of the motor has reached one of the fourth and fifth preset speeds in a short time.

19. The disk discrimination method according to claim 18, wherein the fourth preset speed is determined on an assumption of an HD-DVD-RAM disk and the fifth preset speed is determined on an assumption of an HD-DVD-R disk or an HD-DVD-RW disk.

20. The disk discrimination method according to claim 18, wherein it is determined that the optical disk that is loaded is an HD-DVD-ROM disk in a case where the rotation speed of the motor fails to reach any one of the fourth and fifth preset speeds in a short time.
